(19) United States
(12) Patent Application Publication
(10) Pub. No.: US 2026/0171380 A1
(43) Pub. Date: Jun. 18, 2026

(54) DEVICE AND METHOD FOR HIGH RESOLUTION BEAM ANALYSIS

(71) Applicant: LUXEMBOURG INSTITUTE OF SCIENCE AND TECHNOLOGY (LIST), Esch-sur-Alzette (LU)

(72) Inventor: Hung Quang HOANG, Esch-sur-Alzette (LU)

(21) Appl. No.: 19/119,950

(22) PCT Filed: Oct. 11, 2023
(86) PCT No.: PCT/EP2023/078222

§ 371 Date: Apr. 10, 2025

(30) Foreign Application Priority Data
Oct. 12, 2022 (LU) LU502891

(51) Int. Cl. H01J 49/02

(52) U.S. Cl. CPC H01J 49/025

(57) ABSTRACT

A device and method for recording spectral information of charged particle beams, such as ion beams, or of light beams, at a high resolution. Specifically, a mass spectrometer having a focal plane detector. The device and method enable the recording of mass spectral data at both high mass resolving power and mass accuracy, during parallel acquisition of potentially the entire spectrum of a sample beam.

### TECHNICAL FIELD

The invention lies in the field of charged particle or light detection devices and methods. In particular, the invention relates to analytical devices such as mass spectrometers, such as but not limited to Secondary Ion Mass Spectrometers, SIMS, in which high mass resolving power and mass accuracy are required

### BACKGROUND OF THE INVENTION

In known mass spectrometer devices, an ion beam carrying ions of different species extracted from a sample is analyzed by separating the constituent ion species, wherein each ion species has a given mass-to-charge ratio. Similarly, in light spectrometry, a spectroscope separates different wavelengths that are carried by a light beam. In known magnetic sector mass spectrometer devices, an electrostatic sector is followed downstream in the direction of the ion beam by a magnetic sector instrument. The arrangement of the electrostatic sector and the magnetic sector typically allows for dispersing a wide range of ion masses m/z along the exit plane of the magnetic sector. A detector is then able to collect and count the ions of each beam at different locations along the dispersed range. The collected data, indicating mass-to-charge ratios that correspond to a distance along the detector, and ion intensities, which correspond to the respectively counted ion species per mass-to-charge ratio, forms a representation of the mass spectrum of the sample.

Sector field type mass analyzers, which have a focal plane covering a wide mass range, are typically classified to Mattauch-Herzog type mass analyzers. All the ion masses m/z are focused on a focal plane located at the exit plane (in the original Mattauch-Herzog configuration) or at a distance from the exit plane of the magnetic sector. Most of the Mattauch-Herzog type mass spectrometers are able to operate in the double focusing condition (achromatic mass filtering) for the highest mass resolving power. Typical mass resolving powers from hundreds to thousands are achieved in known devices.

An interesting feature of this type of spectrometer device is its capability to simultaneously capture a wide range of ion species, provided that it is equipped with an appropriate detection system with a focal plane detector. A focal plane detector is able to simultaneously acquire the full mass spectrum in a short acquisition time, typically in a fraction of a second. This simultaneous acquisition capability offers several benefits. First, 100% duty cycle of the measurement can be achieved. This benefit can result in better detection limits as well as smaller sample sizes needed for the measurement since all the mass-to-charge ratio (m/z) peaks are collected at the same time. Second, the ability to simultaneously record the entire mass spectrum allows for both continuous and pulsed ionization techniques. In particular, the pulsed ionization techniques such as laser ablation/ionization commonly introduce rapid changes in the spectrum signal and therefore the sequential detection techniques will cause errors in the measurements.

A focal plane detector based on microchannel plates has a major advantage of extremely high sensitivity (single ion/electron detection) thanks to its high amplification gain capability. It also has the flexibility in varying the shape and size to fit into each individual instrument. The detector can be designed to have a length from a few to several centimeters. Therefore, the MCP-based detector technology is currently the most favored technology for mass spectrometry and Secondary Ion Mass Spectrometry, SIMS, applications.

A typical microchannel plate, MCP, device is composed of 10⁴ to 10⁷ miniature electron multipliers whose typical diameters are in the range from 10 to 100 μm. Each channel acts as an individual electron multiplier, which can detect a single ion, electron, atom, molecule or photon. The MCP is typically fabricated from a high resistive material such as lead glass. The front side and rear side of the MCP are metallized electrodes to which a typical voltage difference of about 1000V is applied through appropriate biasing means, such as a source of electricity. When a single energetic particle hits a channel surface, it creates one or more secondary electrons, which are accelerated into an MCP channel by the applied voltage. Each of these secondary electrons can release two or more secondary electrons when hitting the channel wall again. This process is cascaded along the channel. Therefore, a single energetic particle hitting a channel creates a cascade of electron emission along the channel, resulting in an electron cloud of at least 10⁴ electrons at the output of the channel. An anode placed behind the MCP can electronically detect the electron cloud to register each single event hitting the MCP.

Each MCP typically provides an amplification gain of 10⁴. However, in most of the applications, a higher gain (10⁶-10⁷) is required. Several consecutively stacked MCPs can be used to achieve such an increased gain. When using stacked MCPs, the channels of each first layer MCP are tilted 8°-15° against the MCP normal. The channels of the following layer MCPs are tilted in the opposite direction in order to avoid the ion feedback from the successively stacked MCPs. The combination of two layers of stacked MCPs in an assembly in this configuration is called the Chevron assembly, while the combination of three stacked layers of MCPs in an assembly is called the Z-stack assembly. The type of MCP assembly that is integrated into a focal plane detector device depends on the required amplification gain. However, within one device, MCP assemblies of the same channel size and amplification gain are typically used to maintain uniform detection efficiency and spatial resolution along the entire detector

A single channel of the first MCP layer, that is activated in the detection of a particle results in several activated channels of the subsequence plate in the Chevron assembly. There are even more channels to be activated in the third MCP in the Z-stack configuration. Therefore, when a single particle is detected by the first MCP the readout anode will register the signal from several channels. Therefore, the spatial resolution of the MCP, in particular in the stack assembles, is limited by several MCP channels, which is typical in the range of several micrometers to hundreds of micrometers. While increasing the gain of the detected signal, its spatial resolution drops.

MCP-based detectors are of similar use in the field of light beam analysis, when used together with spectroscopy devices.

The resolving power of a mass spectrometer provides a measure of a device's ability to separate two peaks of slightly different mass-to-charge ratios in the resulting mass spectrum. It is defined as R=m/Δm, where m is the mass number of the observed mass and Δm is the difference between two masses that can be separated. The mass separation is translated into the mass dispersion along the detection plane.

For a given magnetic sector mass spectrometer device, the higher the mass resolving power is, the finer the generated mass spectral lines (or beam widths) are. As a consequence, for a given focal plane detector, the higher mass resolving power results in the smaller number of the detector pixels, which are covered by a spectral line on the focal plane detector. For example, a spectral line produced by a given mass spectrometer device having a mass resolving power of 400 may cover over 10 pixels of the detector, while only 4 pixels may be covered by the spectral line of a mass resolving power of 1200. In the first case, the spectral line can be recovered by the intensity distribution along the covered pixels. In the latter case, it is not possible to recover the accurate spectral line profile due to the limited number of covering discrete pixels, resulting in the detected peak width limited to at least 2 pixels, which is larger than the actual peak width. Therefore, the measured mass resolving power on the detector is poorer than the actual mass resolving of the spectrometer. Considering the statistics of the number of the pixels for rebuild a mass spectral line and the typical pixel size of the MCP-based detector of 50-100 μm, it is only efficient for a focal plane detector to detect mass spectral lines of more than several hundred micrometers without significantly compromising the mass resolution.

Mass accuracy presents how accurate the measured mass value by the spectrometer is in comparison with the actual mass value. The mass accuracy is dependent on several parameters including the characteristics of the mass analyzer such as the mass resolving power, the calibration of the spectrometer, the stability of the electronics, etc. In the magnetic sector mass spectrometer with a focal plane detector, the mass accuracy is also dependent on the spatial resolution or pixel size of the detector. As previously discussed, as a spectral line is represented by the current distribution over a number of discrete pixels on the detector, the maximum achievable mass dispersion accuracy is typically limited to the size of 1 pixel of the detector, no matter how accurate the other mentioned parameters are.

Currently, there are no known devices that provide charged particle detection, which allow high achievable mass resolving power and mass accuracy in magnetic sector spectrometer devices equipped with an MCP-based focal plane detector. The tradeoffs outlined hereabove inherently limit either one of the performance features in any of the known solutions.

### Technical Problem to be Solved

It is an objective of the invention to present a device and method which overcome at least some of the disadvantages of the prior art.

### SUMMARY OF THE INVENTION

In accordance with a first aspect of the invention, an analytical device for analyzing an incoming charged particle beam or light beam is provided. The analytical device comprises a filtering instrument for producing, from said incoming beam, charged particle beams or light beams that are dispersed along a first direction X. The filtering instrument further defines a focal plane extending in the first direction X and in a second direction Z that is perpendicular to said first direction. The device further comprises position-sensitive charged particle or light detection means comprising a detection front extending downstream of, and in parallel to said focal plane.

The analytical device is remarkable in that at least one aperture plate is arranged on said focal plane. The at least one aperture plate comprises at least one high resolution slit extending in said second direction Z, for passing said dispersed charged particle beams or light beams through at a predetermined position of the aperture plate along said first direction X, and displacement means for displacing respective positions along said first direction X, at which said dispersed charged particle beams or light beams arrive on the aperture plate.

Preferably, the displacement means may comprise mechanical or electro-mechanical means for displacing the position of said at least one aperture plate relative to the filtering instrument along said first direction X.

The displacement means may preferably comprise piezo elements configured to selectively shift the position of at least one aperture plate on activation. Alternatively, the displacement means may comprise step-motor elements or automated mechanical manipulators.

The device may preferably comprise an aperture plate holder arranged at said focal plane, wherein said at least one aperture plate is removably coupled to said aperture plate holder.

Preferably, the aperture plate holder may further be configured to selectively hold said at least one aperture plate or said charged particle or light detection means.

The analytical device may preferably comprise a single aperture plate having a plurality of high-resolution slits along said first direction X.

Preferably, the analytical device may comprise plurality of aperture plates, wherein each aperture plates has at least one high resolution slit.

Preferably, the aperture plate may comprise Tungsten, Platinum, Molybdenum or stainless steel. For light beam analysis application, the aperture plate may preferably a low-reflectivity coating.

The width of a high resolution slit along the first direction X may preferably be within 50% to 80% of the spectral peak of the beam it filters. Preferably, the width of a high-resolution slit may be comprised in the range between 5 and 100 micrometers.

The height of a high resolution slit along the second direction Z may preferably in the range from 2 to 10 mm. Preferably, the height of the slit may be chosen so as to be at least as large as the beam width in the Z direction.

Preferably, the detection means may be arranged at a distance of 2 to 10 mm downstream of said aperture plate and focal plane.

The analytical device may further preferably comprise biasing means configured to apply a positive or negative floating electric potential to the aperture plate and to the detection means.

The filtering instrument may preferably comprise a magnetic sector instrument for dispersing ion beams according to their mass-to-charge ratios along said first direction X.

The analytical device may preferably be characterized by locations of elemental dispersion along its focal plane. Preferably, the high-resolution slits of said at least one aperture plate may be arranged so as to coincide with at least a part of said locations.

Preferably, the displacement means may comprise a control unit configured to selectively change the strength of a magnetic field of said magnetic sector instrument, in order to selectively shift the positions of exit points, at which dispersed ion beams exit the magnetic sector instrument.

The position-sensitive charged particle detection means may preferably comprise a focal plane detector having a plurality of microchannel plate devices coupled to a read-out anode. Preferably, the focal plane detector may extend along a distance of at least 10 to 30 cm.

According to another aspect of the invention, a mass spectrometer device is provided. The mass spectrometer device comprises an ion source for producing an ion beam comprising ion species of a sample. The spectrometer is remarkable in that it further comprises an analytical device in accordance with aspects of the invention.

Preferably, the arrangement of the mass spectrometer device may be such that said ion beam comprising ion species of a sample is filtered using said magnetic sector instrument, which disperses said ion species according to their mass-to-charge ratios along said first direction X, before the corresponding dispersed ion beams arrive at said aperture plate.

The mass spectrometer may preferably be configured for being used in a floating configuration.

According to a further aspect of the invention, a method for collecting high resolution spectral data of a sample using a mass spectrometer device in accordance with aspects of the invention is proposed. The method comprises the steps of:
i) causing an ion beam carrying ions from a sample to be filtered by said analytical device, so as to generate a set of ion beams dispersed along said first direction X in accordance with their mass-to-charge ratios;
ii) providing at least one aperture plate on the focal plane, wherein said at least one aperture plate provides at least one high resolution slit in an elemental dispersion position of the spectrometer;
iii) causing a displacement along the first direction X of the positions of the filtered beam's respective impacts on said at least one aperture plate using said displacement means;
iv) during said displacement, collecting position sensitive detection data of the ion beams reaching the ion detection means.

Preferably, at step iii) the strength of the magnetic field within an ion passage of a magnetic sector instrument of the analytical device is changed.

The invention provides devices and methods that enable a high mass resolving capability and a high mass accuracy in magnetic sector mass spectrometers with a focal plane that allow for parallel detection of a wide range of ion species. In accordance with some embodiments of the invention, both continuous parallel detection of the mass spectrum with spectral lines of limited to a few hundred micrometers (typically limited to the mass resolving powers of less than 1000) and parallel detection of series of mass spectral lines with no limitation in the spectral widths (achievable mass resolving power of several thousands) can be obtained. Embodiments of the invention provide for overcoming the limitations of achieving high mass resolving power and high mass accuracy of a magnetic sector mass spectrometer equipped with a focal plane detector due to the constraints in spatial resolution of the focal plane detector. The disclosed concept is based on the incorporation of a preferably movable series of narrow slits onto the focal plane detector system. The narrow slits function as mass filtering by their width while the focal plane detector can function either as signal readout of the slits or as a native position sensitive detector. In a preferred embodiment, the plate or plates carrying the slits and the focal plane detector are both mounted on manipulating mechanisms, which allow them to be positioned in two arrangements: either the focal plane detector is on the focal plane of the mass spectrometer and the slits are removed to a retracted position; or the aperture plates carrying slits are located on the focal plane of the mass spectrometer and the focal plane detector is arranged behind the slits. Both the series of slits and focal plane detector are then involved in the detection process In the first arrangement, the detection system uses the focal plane detector for continuous full parallel acquisition with its native spatial resolution. In the second arrangement at each slit, there is only a narrow part of a spectral line passing through the slit and being detected by the focal plane detector, whereby the mass filtering resolving power at the slit positions is increased. The achieved mass resolving power is defined by the slit sizes, and therefore not limited by the physical constraints of the detector's spatial resolution. While the following description focusses on ion beam detection, the invention is equally useful in the detection of other charged particle beams and light beams carrying different wavelengths of light, which may be spread by optical systems including lenses and prisms: the dispersed light beams may be detected using similar focal plane detectors involving MCPs, the resolution of which is increased by the proposed invention.

### BRIEF DESCRIPTION OF THE DRAWINGS

Several embodiments of the present invention are illustrated by way of figures, which do not limit the scope of the invention, wherein:

FIG. 1 is a schematic illustration of a top view of a cut through an analytical device in accordance with a preferred embodiment of the invention;

FIG. 2 is a schematic illustration of a top view of a cut through a spectrometer device in accordance with a preferred embodiment of the invention;

FIG. 3 is a workflow showing the main steps of a method in accordance with a preferred embodiment of the invention.

### DETAILED DESCRIPTION OF THE INVENTION

This section describes features of the invention in further detail based on preferred embodiments and on the figures, without limiting the invention to the described embodiments. Unless otherwise stated, features described in the context of a specific embodiment may be combined with additional features of other described embodiments. Similar reference numbers will be used to designate similar or the same concepts across different embodiments. For example, numerals 100 and 200 both designate an analytical device, according to two respective embodiments of the invention.

The description puts focus on those aspects that are relevant for understanding the invention. It will be clear to the skilled person that, for example, a device for obtaining mass spectral data also comprises other commonly known aspects, such as for example an appropriately dimensioned power supply, or a mechanical holder frame for holding the various elements of the apparatus in their respectively required positions, even if those aspects are not explicitly mentioned.

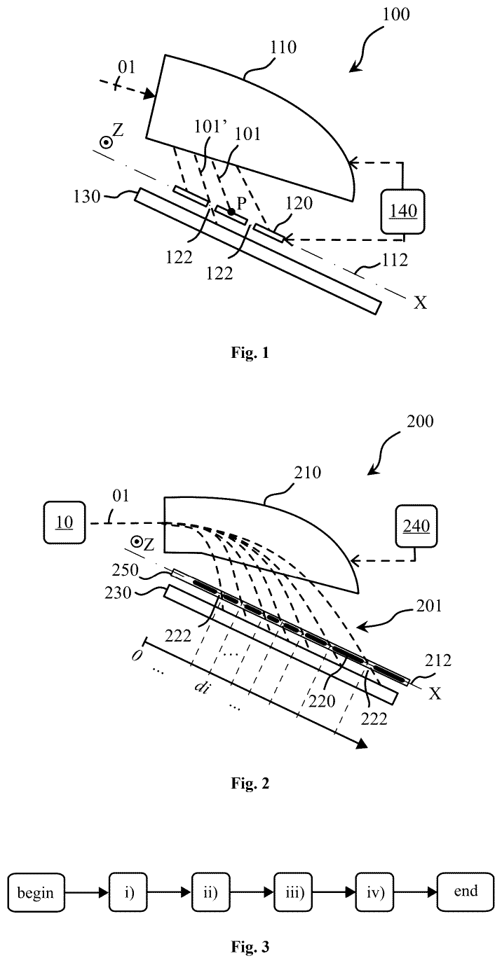

FIG. 1 shows a top view of a cut through an analytical device 100 in accordance with an embodiment of the invention. The device 100 comprises a filtering instrument 110, which, from an input beam 01, generates a plurality of beams 101, 101′ exiting the filtering instrument at positions along an exit face thereof. The beams 101, 101′ are dispersed along a first direction X and typically evolve in a plane that is parallel to the drawing plane of the figure. By way of example, the input beam 01 may be an ion beam carrying different ion species. In that case, the filtering instrument 110 may for example comprise a magnetic sector instrument, as it is known in the art of mass spectrometry. Within the magnetic sector instruments, a gap that evolves in parallel to the drawing plane of the figure allows the ion beam 01 to progress. As a magnetic field is applied through the gap, ion species of different mass-to-charge ratios are deflected at different amplitudes, so that the beams 101, 101′ are dispersed along the first direction X in accordance with the mass-to-charge ratios of the ion species they carry. Alternatively, the input beam 01 may be a light beam carrying multiple wavelengths of light. In that case, the filtering instrument 110 may for example comprise an arrangement of optical lenses and prisms for splitting the different component wavelengths into the beams 101, 101′ along the first direction X.

The filtering instrument 110 defines a focal plane 112 extending in the first direction X and in a second direction Z that is perpendicular to said first direction. The device 100 further comprises position-sensitive charged particle or light detection means 130 comprising a detection front extending downstream of, and in parallel to said focal plane. Typically, the detector is arranged at a distance of 2 to 10 mm from the focal plane, in parallel thereto. The detection front is the entry face of the detector 130. In a preferred embodiment, the detection front comprises the entries of microchannel plate, MCP devices, that are preferably stacked in chevron- or Z-stacks in order to increase their amplification gain. The detector 130 preferably also comprises a readout anode that may be coupled to a computing device: charged particles (electrons, ions) or photons hitting the detector front generated amplified signals along the X axis at the output of the MCP assemblies; these amplified signals, along with their positions, are then detected on the read-out anode. The corresponding data may be stored in a memory element and used to build a spectrum of the analyzed beam 01.

The analytical device 100 is remarkable in that at least one aperture plate 120 is arranged on the focal plane 112. In the illustrated example, one aperture plate 120 comprises two high resolution slits 122 that extend in the second direction Z. If a beam 101′ arrives at the aperture plate at the position of a slit 122, it passes through the slit and hits the detector 130. If a beam 101 arrives at the aperture plate in between slits, the beam, or the corresponding part of the beam width, is blocked. The slits 122 passing said dispersed charged particle beams or light beams through the aperture plate at a predetermined position of the aperture plate along said first direction X. Further, the device 100 comprises displacement means 140 for displacing respective positions along said first direction X, at which said dispersed charged particle beams or light beams arrive on the aperture plate. By way of example: in the illustrated situation, beam 101 hits the aperture plate at position P, in between two slits 122. The position P may be changed either by causing the beam 101 to follow a different trajectory, or by shifting the position of the aperture plate 120 along the first direction X. As such, the beam 101 may pass through one of the slits 122 if the position at which the same beam 101 hits the plane of the aperture plate is altered.

Preferably, the displacement may comprise mechanical or electro-mechanical means such as piezo-elements or a step motor for displacing the position of said at least one aperture plate relative to the filtering instrument along said first direction X.

By displacing the slit 122 (or the beam 101, 101′) during signal acquisition at the detector 130, the beam dispersion shape is convoluted with the width of the slit, and the detected signal is effectively a filtered version of the beam dispersion profile. A slit with a width (or diameter) smaller than the beam width is used to select a part of the beam to be recorded by the detector placed downstream of the slit. In order to record the beam profile, i.e., the spectral peak related to the detected charged particle or light beam, two protocols can be used: either the slit is displaced, or the beam is swept across the slit. In both scenarios, the signal response recorded by the detector can be expressed by the convolution of the ion beam profile and the slit (or sometimes called the response function of the slit). This signal response represents the recorded ion profile (or the spectral peak) by the detector. For the applications considered by the present invention, slit widths of 50-80% of the beam profile generated by the filtering instrument 110 are typically used, so the detected spectral profile is still close to the intrinsic peak, with a good Signal-to-Noise Ratio, SNR. The use of the slits increases the high-resolution capability of the instrument. Therefore, the slits 122 are also referred to as high resolution slits, or, in the case of ion beams, as high mass resolving power slits. Specifically, in conjunction with an MCP focal plane detector, high ion counts can be achieved during parallel acquisition of the complete spectrum at a high mass resolving power, which provides an advantage as compared to known devices.

The use of an aperture plate 120 having a slit at a given position along the first direction X will increase the resolution of the detection system at that position. As such, an aperture plate can be selectively placed in a part of the detection area along the first direction, to have the corresponding part of the spectrum recorded at high resolution, while the remaining part of the spectrum, where not aperture plate is present, is recorded at the same time at a lower resolution. Indeed, the detector 130, being located downstream of the focal plane, may be considered to be out of focus for beams that are not scanned through a high-resolution slit. This mode of operation may be referred to as a “hybrid” mode, as at the same time of recording, one or more regions of interest of the spectrum of beam 01 may be recorded at a higher resolution than other regions of the spectrum. As such, the device 100 may comprise either a single aperture plate having a plurality of high-resolution slits along the first direction, or a plurality of such plates, wherein each aperture plates has at least one such high resolution slit.

A non-illustrated mechanical holder structure may be used to removably receive the at least one aperture plate on the focal plane. In a preferred embodiment, the holder may be designed so that it can either receive the aperture plate(s) or the focal plane detector 130. This allows for increased flexibility of the device: when no region of the spectrum is of increased interest, the focal plane detector 130 is moved to the holder and arranged on the analytical device's focal plane. This arrangement allows for full parallel acquisition of the spectral information.

If a region is of increased interest, the focal plane detector is removed from the holder and installed downstream thereof at a distance from the focal plane, while the aperture plate 120 is installed in the holder on the focal plane. The detector 130 then acts as read-out for the signal that is filtered by the slit 122 by the relative displacement of the beam 101, 101′ with respect to the slit.

The detecting means and aperture plates may preferably be able to be floated to a high voltage of up to 10 kV, while the floating potential may have either positive or negative polarity. Electrical biasing means may be operatively connected to the detecting means and aperture plates for providing these electric potentials if required.

FIG. 2 shows a preferred embodiment of the analytical device 200 in accordance with the invention. A source of ions 10 provides an ion beam carrying ion species extracted from a sample, as is known in the art. The device 10 may for example comprise the ion extraction device and sector instruments for focusing the beam 01 before it arrives at the analytical device 200. Together with the source of ions 10, the analytical device 200 forms a spectrometer.

The device 200 comprises a filtering instrument 210, which is a magnetic sector instrument. From an input ion beam 01, the magnetic sector instrument 210 generates a plurality of ion beams 201 exiting the magnetic sector instrument at different positions along an exit face thereof. The ion beams 201 are dispersed along a first direction X and typically evolve in a plane that is parallel to the drawing plane of the figure. Within the magnetic sector instrument, a gap that evolves in parallel to the drawing plane of the figure allows the ion beam 01 to progress. As a magnetic field is applied through the gap, ion species of different mass-to-charge ratios are deflected at different amplitudes, so that the beams 201 are dispersed along the first direction X in accordance with the mass-to-charge ratios of the ion species they carry.

The magnetic sector instrument 210 defines a focal plane 212 extending in the first direction X and in a second direction Z that is perpendicular to said first direction. The device 200 further comprises position-sensitive charged particle detection means 230 comprising a detection front extending downstream of, and in parallel to said focal plane. Typically, the detector is arranged at a distance of 2 to 10 mm from the focal plane, in parallel thereto. The detection front is the entry face of the detector 230. The detection front comprises the entries of microchannel plate, MCP devices, that are preferably stacked in chevron- or Z-stacks in order to increase their amplification gain. The detector 230 also comprises a readout anode that may be coupled to a computing device: ion species hitting the detector front generate amplified signals along the X axis at the output of the MCP assemblies; these amplified signals, along with their positions, are then detected on the read-out anode. The corresponding data may be stored in a memory element and used to build a spectrum of the analyzed ion beam 01.

The analytical device 200 is remarkable in that an aperture plate 220 is arranged on the focal plane 212, held in place by a mechanical holder device 250. As explained in the context of the previous embodiment, the holder 250 is preferably capable to alternatively hold the detector 130. In the illustrated example, one aperture plate 220 comprises a series of high mass resolving power slits 222 that extend in the second direction Z. Along the focal plane detector, the positions of the high mass resolving power slits are chosen to coincide with the locations of the elemental dispersion of the mass spectrometer along its focal plane. A typical example of the mass dispersion characteristic of a Mattauch-Herzog mass spectrometer is expressed as the square-root function of the mass. In this case, the positions of the slits can be defined as following

$${d}_{i} = a \sqrt{{m}_{i}} + b$$

Where dᵢ is the position of the slit used to record an element indexed by i, mᵢ is the mass of the element indexed by i, a and b are the mass dispersion coefficients. In other mass spectrometer configurations, the mass dispersion characteristics can be different from the above example, but the principle to place the slits at elemental mass dispersion positions remains. The complete mass spectrum including all the isotopes and compositions can be acquired by scanning the magnetic field in a narrow range, which allows the shift of an element mᵢ at position dᵢ to either the position dᵢ₊₁ or dᵢ₋₁.

Specifically, the device 200 comprises a control unit 240 operatively coupled to an electromagnet that generates the magnetic field within the gap space of the magnetic sector instrument 210. The control unit may comprise an integrated circuit or an appropriately programmed computer chip. It implements the displacement means together with said electromagnet: as the magnetic field is changed within a narrow range, the exit points at which of the ion beams 201 exit the magnetic sector device 210 are slightly changed, which allows for scanning them quickly and accurately across the slits 222 of the aperture plate 212 in parallel. While the working principle remains the same as in the previously described embodiment, this arrangement has the advantage of not relying on mechanical parts, and of allowing for recording the full mass spectrum of the ion beam 01 in parallel at high mass resolution and at high mass accuracy.

FIG. 3 illustrates the main steps of the spectrum acquisition that has been described in the context of the embodiments of the disclosed analytical devices.

At a first step i), an ion beam carrying ions from a sample is caused to be filtered by the analytical device according to embodiments of the invention, so as to generate a set of ion beams dispersed along the first direction X in accordance with their mass-to-charge ratios. At step ii) at least one aperture plate on the focal plane, wherein said at least one aperture plate provides at least one high resolution slit in an elemental dispersion position of the spectrometer. This step may of course be carried out in parallel or prior to step i). A displacement along the first direction X of the positions of the filtered beams' respective impact locations on said at least one aperture plate is caused using said displacement means at step iii). Finally, during said displacement, position sensitive detection of data of the ion beams reaching the ion detection means is performed, resulting in the parallel acquisition of high-resolution spectral data.

It should be understood that the detailed description of specific preferred embodiments is given by way of illustration only, since various changes and modifications within the scope of the invention will be apparent to the skilled person. The scope of protection is defined by the following set of claims.

1. An analytical device for analyzing an incoming charged particle beam or light beam, the analytical device comprising:
a filtering instrument for producing, from said incoming charged particle beam or light beam, charged particle beams or light beams that are dispersed along a first direction, the filtering instrument further defining a focal plane extending in the first direction and in a second direction that is perpendicular to said first direction;
position-sensitive charged particle or light detection means comprising a detection front extending downstream of, and in parallel to, said focal plane;
at least one aperture plate is arranged on said focal plane, the aperture plate defining at least one high resolution slit extending in said second direction, for passing said dispersed charged particle beams or light beams through at a predetermined position of the aperture plate along said first direction, and
displacement means for displacing respective positions along said first direction, at which said dispersed charged particle beams or light beams arrive on the aperture plate.

2. The analytical device according to claim 1, wherein said displacement means comprise mechanical or electro-mechanical means for displacing the position of said at least one aperture plate relative to the filtering instrument along said first direction.

3. The analytical device according to claim 1, further comprising an aperture plate holder arranged at said focal plane, wherein said at least one aperture plate is removably coupled to said aperture plate holder.

4. The analytical device according to claim 4, wherein the aperture plate holder is further configured to selectively hold said at least one aperture plate or said charged particle or light detection means.

5. The analytical device according to claim 1, further comprising a single aperture plate defining a plurality of high-resolution slits along said first direction.

6. The analytical device according to claim 1, further comprising a plurality of aperture plates, wherein each aperture plate defines at least one high resolution slit.

7. The analytical device according to claim 1, wherein the detection means are arranged at a distance of 2 to 10 mm downstream of said aperture plate and said focal plane.

8. The analytical device according to claim 1, further comprising biasing means configured to apply a positive or negative floating electric potential to the aperture plate and to the detection means.

9. The analytical device according to claim 1, wherein the filtering instrument comprises a magnetic sector instrument for dispersing ion beams according to their mass-to-charge ratios along said first direction.

10. The analytical device according to claim 9, wherein the analytical device is characterized by locations of elemental dispersion along the focal plane, and wherein the high-resolution slits of said at least one aperture plate are arranged so as to coincide with at least a part of said locations.

11. The analytical device according to claim 9, wherein said displacement means comprise a control unit configured to selectively change a strength of a magnetic field of said magnetic sector instrument, in order to selectively shift the positions of exit points, at which dispersed ion beams exit the magnetic sector instrument.

12. The analytical device according to claim 9, wherein said position-sensitive charged particle detection means comprise a focal plane detector including a plurality of microchannel plate devices coupled to a read-out anode.

13. A mass spectrometer device comprising an ion source for producing the incoming charged particle beam comprising ion species of a sample, the mass spectrometer device further comprising the analytical device in accordance with claim 9.

14. The mass spectrometer device according to claim 13, wherein said ion beam comprising the ion species of the sample is filtered using said magnetic sector instrument, which disperses said ion species according to their mass-to-charge ratios along said first direction, before the corresponding dispersed ion beams arrive at said aperture plate.

15. A method for collecting high resolution spectral data of the sample using the mass spectrometer device in accordance with claim 13, the method comprising the steps of:
i) causing the ion beam carrying ions from the sample to be filtered by said analytical device, so as to generate a set of ion beams dispersed along said first direction in accordance with their mass-to-charge ratios;
ii) providing the at least one aperture plate on the focal plane, wherein said at least one aperture plate provides the at least one high resolution slit in an elemental dispersion position of the spectrometer;
iii) causing a displacement along the first direction of the positions of the filtered beam's respective impacts on said at least one aperture plate using said displacement means;
iv) during said displacement, collecting position sensitive detection data of the ion beams reaching the ion detection means.

16. The method according to claim 15, wherein at step iii), a strength of the magnetic field within an ion passage of a magnetic sector instrument of the analytical device is changed.
